(19) United States
(12) Patent Application Publication
(10) Pub. No.: US 2008/0195406 A1
(43) Pub. Date: Aug. 14, 2008

(54) COMMUNICATION CONTROL CHARGING SYSTEM, COMMUNICATION CONTROL CHARGING METHOD, AND COMMUNICATION CONTROL CHARGING PROGRAM

(76) Inventor: KOICHI MATSUMOTO, Tokyo (JP)

Correspondence Address: NEC CORPORATION OF AMERICA, 6535 N. STATE HWY 161, IRVING, TX, 75039, US

(21) Appl. No.: 12/016,340

(22) Filed: Jan. 18, 2008

(30) Foreign Application Priority Data
Feb. 13, 2007 (JP) 2007-032753

(51) Int. Cl. G06Q 10/00; G06Q 99/00

(52) U.S. Cl. 705/1; 705/400

(57) ABSTRACT

To provide a system, a method, and a program for enabling controls over communication sessions and charging of communication fees according to the communication sessions, which can easily be introduced to existing communication authentication systems. When a communication terminal connected to a corporate network tries to perform a mutual communication with a partner terminal that is connected to a provider terminal, an authentication managing unit provided in advance to the provider network performs communication access authentication for the communication terminal. Further, the authentication managing unit controls establishment of the mutual communication between the authenticated communication terminal and the partner terminal, and manages a communication fee according to the communication session.

### CROSS-REFERENCE TO RELATED APPLICATION

This application is based upon and claims the benefit of priority from Japanese patent application No. 2007-032753, filed on Feb. 13, 2007, the disclosure of which is incorporated herein in its entirety by reference.

### BACKGROUND OF THE INVENTION

1. Field of the Invention

The present invention relates to a communication control charging system, a communication control charging method, and a communication control charging program for controlling approvals on communications performed between a communication terminal and a partner terminal via a communication network.

2. Description of the Related Art

When a communication network provided within a corporate or private facility (referred to as an “corporate network” hereinafter) is used by a user that does not belong to this corporate (referred to as a “guest user” hereinafter), it is difficult for the owner or the management side of this corporate network to properly collect the communication cost for the usage thereof from the guest user as an equivalent value of a service.

That is, in order to charge a proper communication cost in accordance with a communication service used by a guest user, it is necessary to provide large-scaled network equipment for performing complicated processing, e.g. an authentication device, a session control device, and a charging device, within the corporate network for providing a service such as a roaming service performed between networks of communication providers as shown in FIG. 13, for example.

In a structure of the network disclosed in FIG. 13, a network 60 of a communication provider A and a network 70 of a communication provider B are connected to each other so that a communication terminal 51 communicatively connected to the network 60 of the communication provider A and a partner terminal 52 communicatively connected to the network 70 of the communication provider B are connected to be capable of performing mutual communications with each other.

The network 60 of the communication provider A described above includes a network managing unit 61 of the communication provider A for managing communication accesses of the communication terminal 51. This network managing unit 61 of the communication provider A is configured with: an access authentication device 62 for giving authentication on the communication accesses of the communication terminal 51 and authentication on communication accesses from the network 70 of the communication provider B; a session control device 63 for controlling establishment and ending of the communication sessions between the access-authenticated communication terminal 51 and the network 70 of the communication provider B; and a charging information managing device 64 which charges a communication fee in accordance with the communication session established by the session control device 63 and manages the charging information.

Further, the network 70 of the communication provider B described above is also configured in the same manner, and it is provided with a network managing unit 71 of the communication provider B for managing communication accesses of the partner terminal 52. This network managing unit 71 of the communication provider B is configured with: an access authentication device 72 for performing authentication on the communication accesses of the partner communication terminal 52 and authentication on communication accesses from the network 60 of the communication provider A; a session control device 73 for controlling establishment and ending of communication sessions between the access-authenticated partner terminal 52 and the network 60 of the communication provider A; and a charging information managing device 74 which charges a communication fee in accordance with the communication session established by the session control device 73 and manages the charging information.

With such network structure, the communication terminal 51, for example, can establish a communication session with the partner terminal 52 and charge a communication fee according to the communication session by receiving access authentication from the network 60 of the communication provider A and the network 70 of the communication provider B, respectively, with the use of an authentication ID and authentication password which are allotted in advance.

When a guest user performs communications by using a corporate network, there may be cases where contents of communication data are analyzed as a security measure within the corporate network or cases where the communication data of the guest user becomes a target of wiretappings, data leakages, or the like.

In order for the communication providers to guarantee the security and confidentiality of the communication data of the user based on a contract even in such cases, it has been necessary to provide large-scaled network equipment such as the above-described roaming service within the corporate network.

For this, there is disclosed a method in which a dynamically changeable IP address is allotted to each of user terminals of a corporate network from a network of a communication provider, and authentication processing as well as charging processing is performed based on the IP address by the provider (see Japanese Unexamined Patent Publication 2003-87299 (Patent Document 1)).

However, as described above, it is not possible with the changing processing method of the above-described example to secure the confidentiality of the communication performed by the guest user. Further, a mechanism for controlling the communication sessions between the guest user and a terminal (server or the like) of the communication provider side set in advance is mounted on the corporate network side (router in this case), so that it is not easy to be introduced to existing communication authentication systems.

Therefore, when the guest user communicates with an external network (for example, a network of the communication provider or the Internet) by using the corporate network, it is not possible to charge a proper communication cost according to the extent of the communication service used by the guest user, without using a complicated and large-scaled network structure.

Further, with the above-described example, there is a possibility that the communication data of the guest user in the corporate network may become the target of wiretappings or data leakages. Thus, it is not possible to secure the confidentiality of the communication.

### SUMMARY OF THE INVENTION

It is an exemplary object of the present invention to improve the aforementioned inconveniences and to provide a communication control charging system, a communication control charging method, and a communication control charging program, which can be introduced easily to existing communication authentication and communication control systems to be used instead of complicated existing communication authentication and communication control systems which require high management cost, and can perform proper charging of communication fees according to the communication sessions.

In order to achieve the exemplary object, a communication control charging system according to an exemplary aspect of the invention includes: a local network to which at least one communication terminal is connected; an inter-network connecting device which is a part of the local network and is connected to an external network; and a partner terminal connected to the external network, wherein the external network is provided with an authentication managing unit for performing access authentication of the communication terminal when the communication terminal makes a communication access to the local network. The authentication managing unit includes a communication session control function for controlling establishment of a mutual communication session between the communication terminal and the partner terminal, and a communication charging managing function for managing a communication fee according to the communication session.

In this structure, the communication session establishing function for establishing the mutual communication between the communication terminal and the partner terminal as well as the charging information managing function are provided in advance to the authentication managing unit of the external network, and the local network side only performs a regulating control of communications. As an exemplary advantage according to the invention, this makes it possible to charge the user of the communication terminal properly according to the communication session without having large-scaled network equipment for performing complicated processing provided within the corporate network.

Further, a communication control charging method according to another exemplary aspect of the invention is a method which, when a communication terminal and a partner terminal perform a mutual communication via a local network and an external network, uses an authentication managing unit provided in advance to the external network to control establishment of the mutual communication session between the communication terminal and the partner terminal, and to charge a communication fee for the communication session. The method includes: an access authentication requesting step for requesting an access authentication from the communication terminal to the authentication managing unit, prior to making an access communication to the local network; a communication authentication allotting step for performing communication access authentication by the authentication managing unit through allotting, to the communication terminal, a communication parameter for allowing a communication access in response to the received access authentication request; a communication session establishing step for establishing the communication session between the communication terminal that has obtained the access authentication and the partner terminal; and a communication charging step for stopping the established communication session and calculating charging information.

Through performing the access authentication by the authentication managing unit of the external network prior to execution of the communication session control on the mutual communication between the communication terminal and the partner terminal, the corporate network (inter-network connecting device) can perform the proper communication session pass control. As an exemplary advantage according to the invention, it becomes possible to charge the communication terminal user properly according to the communication session.

Further, a communication control charging program according to still another exemplary aspect of the invention is a program which, when a communication terminal and a partner terminal perform a mutual communication via a local network and an external network, controls establishment of a mutual communication session between the communication terminal and the partner terminal, and charges a communication fee for the communication session. The program allows a computer to execute: a communication parameter allotting function for allotting a communication parameter for allowing a communication access in response to a communication access request that is sent from the communication terminal to the local network; a communication session control function for establishing the communication session between the communication terminal that has obtained the communication parameter and the partner terminal that is specified in advance as a communicating destination, and for controlling the communication session; and a charging information storing function for generating session identifying information to specify the established communication session, as well as for calculating and storing communication fee information based on the session identifying information.

This makes it possible to promptly specify the communication session that is established between the communication terminal and the partner terminal based on the session identifying information. As an exemplary advantage according to the invention, it becomes possible to perform the regulating control of the communications properly and to charge the communication fee properly by each communication session.

In the present invention, the communication session establishing function for establishing the mutual communication between the communication terminal and the partner terminal as well as the charging information managing function are provided in advance to the authentication managing unit of the external network, and the local network side only performs a regulating control of communications. With this, as an exemplary advantage according to the invention, it becomes possible to provide a communication control charging system and the like, which are capable of controlling establishment of the communication session and capable of properly charging the user according to the communication session on the external network side, and are easily introduced to a communication authentication and communication control system configured with an existing local network and an external network.

### BRIEF DESCRIPTION OF THE DRAWINGS

FIG. 1 is a schematic block diagram showing an entire network according to an exemplary embodiment of a communication control charging system of the present invention;

FIG. 2 is a schematic block diagram showing an structural example of the entire network of the communication control charging system disclosed in FIG. 1;

FIG. 3 illustrates the communication control charging system disclosed in FIG. 1, in which FIG. 3A is an illustration for describing a content of an access request message sent from a communication terminal to an access request proxy device, FIG. 3B is an illustration for describing a content of an access response message sent from the access request proxy device to the communication terminal, and FIG. 3C is an illustration for describing an example of an IP address list stored within an access device;

FIG. 4 illustrates the communication control charging system disclosed in FIG. 1, in which FIG. 4A is a flowchart that schematically shows processing steps when the access device receives an IP packet from the communication terminal, FIG. 4B is a schematic illustration for describing a content of an access proxy request message sent from the access request proxy device to an access authentication device, and FIG. 4C is a schematic illustration for describing a content of an access proxy response message sent from the access authentication device to the access request proxy device;

FIG. 5 illustrates the communication control charging system disclosed in FIG. 1, in which FIG. 5A is a schematic illustration for describing a content of a session pass request message sent from a session control device to a gateway control device, and FIG. 5B is a schematic illustration for describing a content of a session pass response message sent from the gateway control device to the session control device;

FIG. 6 illustrates the communication control charging system disclosed in FIG. 1, in which FIG. 6A is a flowchart that schematically shows processing steps when the gateway control device receives the session pass request from the session control device, and FIG. 6B is an illustration for describing an example of a charging request message that is stored in a charging calculation device;

FIG. 7 illustrates the communication control charging system disclosed in FIG. 1, which schematically shows a flowchart of processing steps when the access authentication device receives the access proxy request message from the access request proxy device;

FIG. 8 illustrates the communication control charging system disclosed in FIG. 1, in which FIG. 8A is a schematic illustration for describing a content of a session start request message sent from the communication terminal to the session control device, and FIG. 8B is a schematic illustration for describing a content of a session start response message sent from the session control device to the communication terminal;

FIG. 9 is a schematic block diagram showing mutual communications performed between an encoder and a decoder of the communication control charging system disclosed in FIG. 1;

FIG. 10 is a schematic block diagram showing a mutual communication performed between the encoder and the decoder of the communication control charging system disclosed in FIG. 1, when the mutual communication session is established between the communication terminal and a partner terminal;

FIG. 11 is a communication sequence chart showing timings of communication operations performed mutually among the communication terminal, a corporate network, a communication managing unit, and the partner terminal according to the exemplary embodiment of the communication control charging system disclosed in FIG. 1;

FIG. 12 is a communication sequence chart showing timings of communication operations performed mutually among the communication terminal, the corporate network, the communication managing unit, and the partner terminal according to the exemplary embodiment of the communication control charging system disclosed in FIG. 1; and

FIG. 13 is a schematic block diagram showing an entire network system of a related communication authentication system.

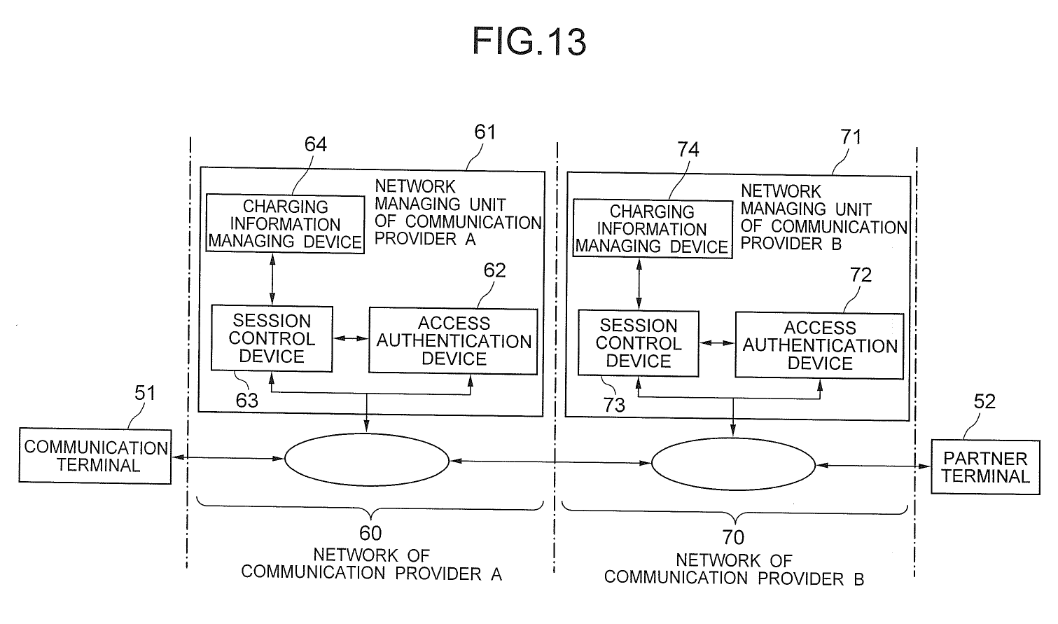

### EXEMPLARY EMBODIMENTS

Next, exemplary embodiments of the invention will be described in detail by referring to the accompanying drawings.

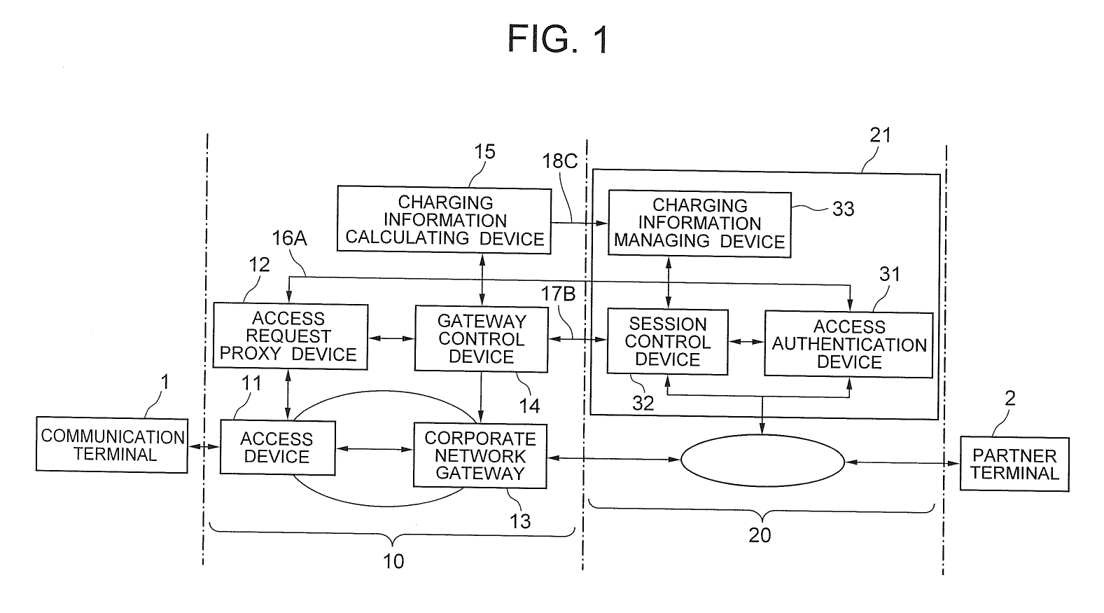

As shown in FIG. 1, an exemplary embodiment of the invention includes a corporate network 10 as a local area network (LAN) provided within a facility of a corporate and an external network connected to the corporate network 10 via a communication line. The external network in this exemplary embodiment is assumed to be a network (referred to as a “provider network” hereinafter) 20 of a communication provider (ISP: Internet Service Provider) that provides an Internet communication service to the communication network 10. Further, this exemplary embodiment includes a communication terminal 1 connected to the corporate network 10 via the communication line and a partner terminal 2 connected to the provider network 20, in which the communication terminal 1 and the partner terminal 2 are connected via the corporate network 10 and the provider network 20 to be able to communicate with each other.

The above-described communication terminal 1 is placed in such a state that it can be utilized by guest users who do not belong to the corporate at which the corporate network 10 is provided, and a user ID and a password are allotted in advance to each guest user.

The corporate network 10 includes: an access device 11 for providing, to the above-described communication terminal 1, a communication accessibility for the corporate network 10; and an access request proxy device 12 that receives an access request from the communication terminal 1 via the access device 11, and sends an access request on behalf of the above-described communication terminal 1. Further, the corporate network 10 includes: a corporate network gateway (corresponds to an inter-network connecting device between networks) 13 connected to the above-described provider network 20 via a communication line; a gateway control device 14 for performing regulating controls on communications performed through the corporate network gateway 13; and a charging information calculating device 15 that is connected to the gateway control device 14 to calculate charged communication fees of the communications performed by the above-described communication terminal 1.

The provider network 20 includes an authentication managing unit 21 which is a part of the provider network 20 and performs authentications on the communication accesses made by the above-described communication terminal 1.

This authentication managing unit 21 includes: an access authentication device 31 for performing access authentication on the communication terminal 1 for allowing an access to the corporate network 10; a session control device for establishing a communication session through mutually connecting the communication terminal 1 that has been access-authenticated and the partner terminal 2; and a charging information managing device 33 for storing communication fees according to each of the established communication sessions.

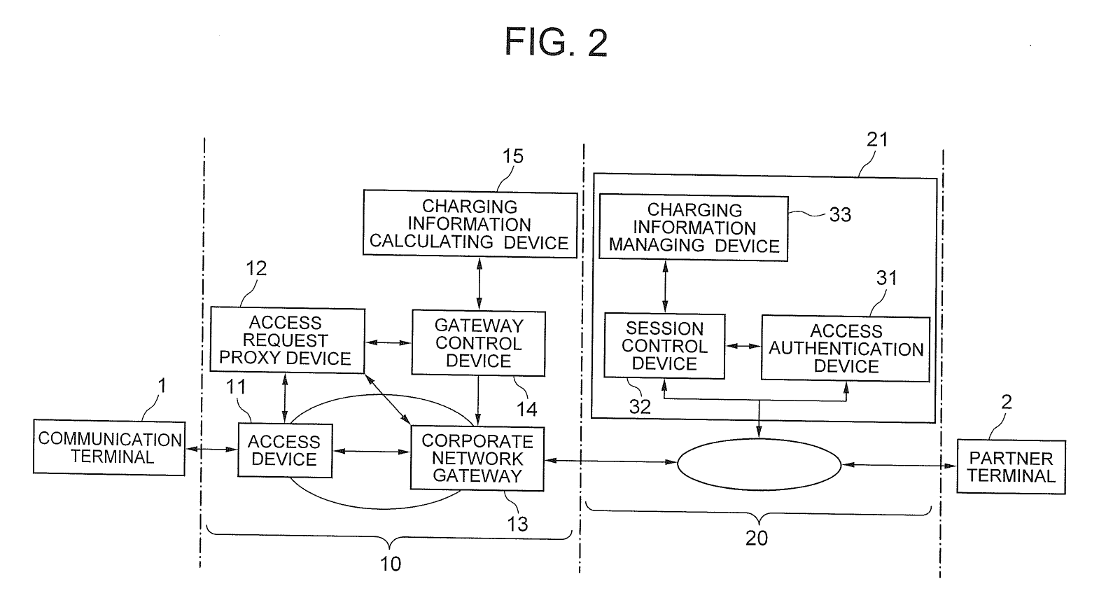

A mutual communication 16A performed between the gateway control device 14 and the session control device 32, a mutual communication 17B performed between the access request proxy device and the access authentication device 31, and a communication 18C from the charging information calculating device 15 to the charging information managing device 33 shown in FIG. 1 are actually executed via the corporate network gateway 13, respectively, as shown in FIG. 2.

Hereinafter, each of the structures of the above-described exemplary embodiment will be described in more details.

The access device 11 of the corporate network 10 described above includes an access request transferring function which receives, from the communication terminal 1, a message (referred to as an “access request” hereinafter) for requesting an authentication necessary for making a communication access to the corporate network 10, and transfers the access request to the access request proxy device 12.

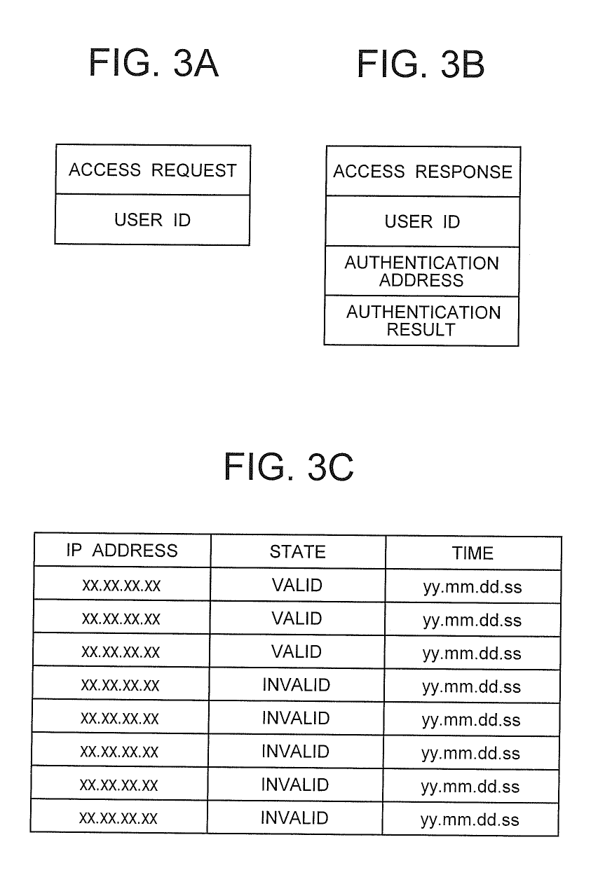

Further, the access device 11 includes: an allotted address storing function for storing an IP address, which is allotted to the communication terminal 1 from the access authentication device 31 of the authentication managing unit 21, to an IP address list provide in advance; and a packet pass control function for determining whether or not to let through the IP packet through judging whether or not the IP address of the sender of the IP packet that is sent from the communication terminal 1 matches with the IP address in the IP address list. Data formats of the above-described access request and access response are shown in FIG. 3A and FIG. 3B, respectively.

Further, an example of a data format of the above-described IP address list is shown in FIG. 3C. The IP address stored in the IP address list is an authentication address that is allotted to the user of the communication terminal 1 when the user is authenticated by the access authentication device 31.

Furthermore, when the access device 11 permits a communication of the received IP address packet based on the IP address list, the IP packet is sent to the corporate network gateway 13.

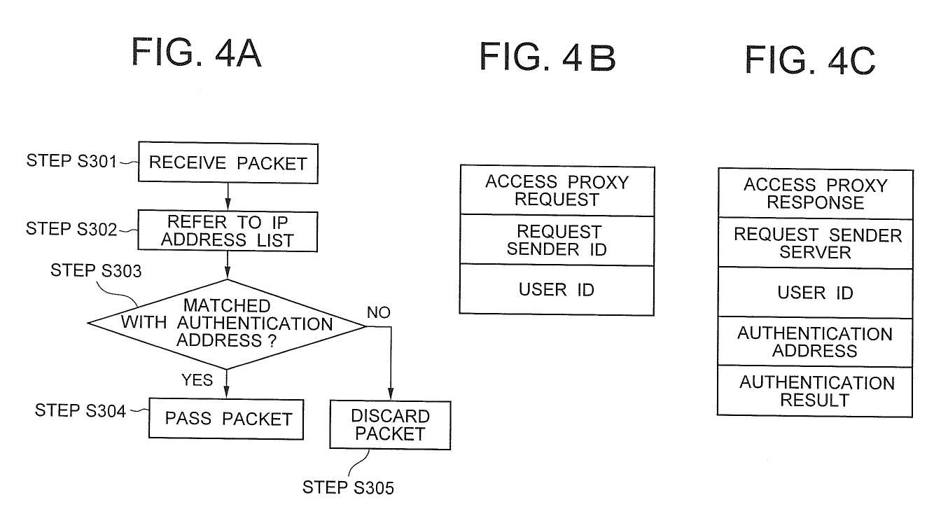

Now, an action of the access device 11 at the time of receiving an IP packet sent from the communication terminal 1 will be described by referring to a flowchart of FIG. 4A.

First, the access device 11 receives an IP packet (for example, a communication authentication request) from the communication terminal 1 that has been access-authenticated (step S301). Then, the access device 11 refers to the IP address list to check whether or not there is a match with the address of the sender of the received IP packet (step S302).

When the address of the sender of the IP packet matches with the content of the IP address list (that is, when the address of the sender is judged to be an allotted authentication address) (step S303), the IP packet is let through (step S304). When the address of the sender of the IP packet does not match with the content of the IP address list (that is, when the address of the sender is judged not to be an allotted authentication address), the IP packet is discarded (step S305).

However, as described above, when the access device 11 receives an access request from the communication terminal 1, the access device 11 transfers the access request to the access request proxy device 12.

The access request proxy device 12 includes an access proxy request function which gives identifying information of the access request proxy device 12 to the access request as an access request sender ID at the time of receiving the access request from the access device 11, and transmits it to the access authentication device 22 of the provider network 20 as an access proxy request.

Further, the access request proxy device 12 includes an access response transferring function for transmitting, to the communication terminal 1, an access proxy response that is sent in response to the access proxy request. When the access is authenticated by the access authentication device 22, an authentication address allotted by the communication terminal 1 is given to the received access proxy response. Example of data formats of the above-described access proxy request and the access proxy response are shown in FIG. 4A and FIG. 4B, respectively.

Furthermore, the access request proxy device 12 includes an authentication address informing function for informing, to the gateway control device 14, the authentication address that is given to the access proxy response.

The corporate network gateway 13 includes: an inter-network communication regulating function for permitting or shutting off IP packet communications performed mutually between the corporate network 10 and the provider network 20 through operations based on controls performed by the gateway control device 14; and a communication speed regulating function for regulating transmission rates of the communications performed between the corporate network 10 and the provider network 20 through operations based on controls performed by the gateway control device 14. In this exemplary embodiment, the transmission rate of the minimum communication band set in advance in the corporate network gateway 13 is 30 kbps.

The gateway control device 14 includes: an authentication address storing function for storing the authentication address of the communication terminal 1 informed by the access request proxy device 12 in the IP address list that is set in advance; and an authentication address pass control function (corresponds to a communication access pass control function) for giving an instruction to control the corporate network gateway 13 to permit a communication of the IP packet that has an address stored in the IP address list. An example of the data format of the IP address list is shown in FIG. 3C as described above.

Further, the gateway control device 14 includes a communication session pass control function for giving an instruction to control the corporate network gateway 13 to permit or to shut off mutual communication sessions between the communication terminal 1 and the partner terminal 2 based on a message (a communication session pass request) sent from the session control device 32 to be described later.

Furthermore, the gateway control device 14 includes a communication band setting control function (corresponds to a communication band control function) which sets a communication band used for a communication session established mutually between the communication terminal 1 and the partner terminal 2 based on the communication session pass request, and controls the band of the communication performed via the corporate network gateway 13.

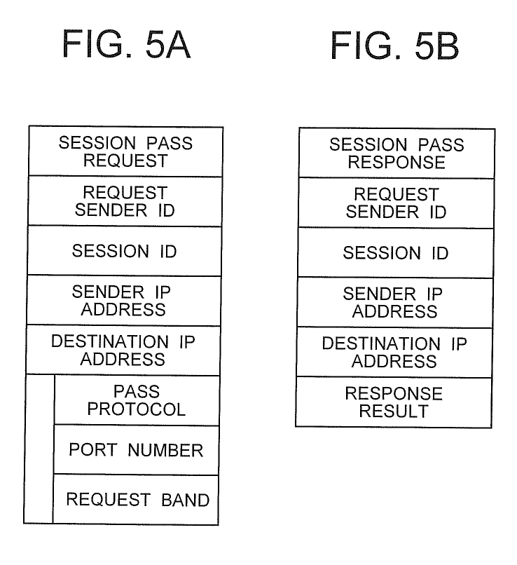

The gateway control device 14 returns a response message (referred to as a “session pass response” hereinafter) indicating whether or not to permit the communication of the established communication session. Examples of the data format of the above-described session pass request and the pass response are shown in FIG. 5A and FIG. 5B, respectively.

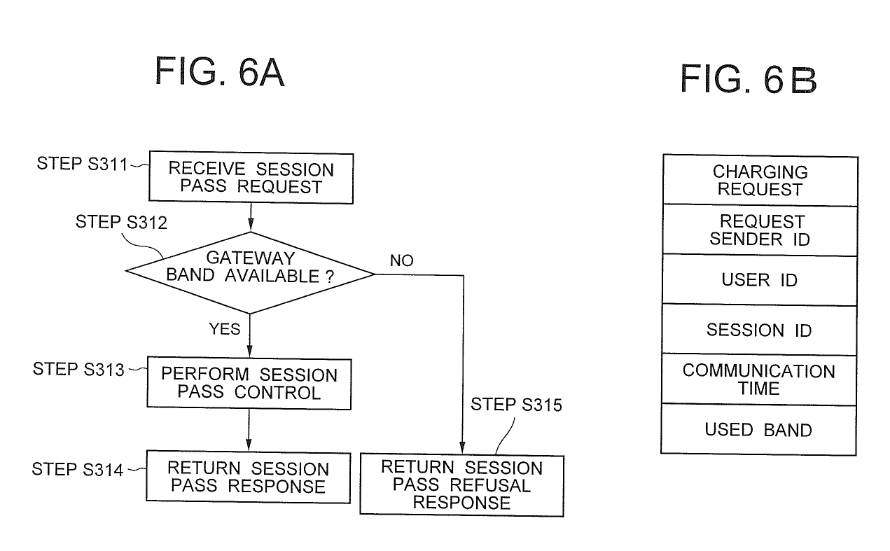

Now, an action of the gateway control device 14 at the time of receiving the session pass request will be described by referring to a flowchart of FIG. 6A.

First, the gateway control device 14 receives a session pass request from the session control device 32 (step S311). Then, the gateway control device 14 checks whether or not there is a vacant port and a usable communication band in the corporate network gateway 13 (step S312). When there is a vacant port and a communication band available in the corporate network gateway 13, the gateway control device 14 permits the communication in a communication session that is specified based on the session pass request, and controls the band for the communication (step S313). Further, the gateway control device 14 returns a session pass response to the session control device 32 (step S314).

In the meantime, when there is no vacant port and no useable communication band in the corporate network gateway 13 (or when the corporate network 10 is being used), the gateway control device 14 returns a session pass refusal response to the session control device 32 (step S315).

The charging information calculating device 15 includes a communication fee calculating function for calculating (charging) communication fees through a calculating method set in advance, based on the communication session identifying information (time of communication, communication band, IP packet amount) that is sent from the gateway control device 14; and a charging information transmitting function for transmitting the calculated communication fee and the session identifying information to the charging information managing device 33. An example of the data format of a register request of the above-described charging information is shown in FIG. 6B.

The communication fee calculating function may be provided to the charging information managing device 33 of the authentication managing unit 21, instead of the charging information calculating device 15.

With this, the charging information list provided to the charging information managing device can be updated promptly without sending the charging information.

The access authentication device 31 of the authentication managing unit 21 includes: an account information storing function for storing, in advance, account information (user ID, password, ID of the communication terminal 1) for authenticating the communication terminal 1 and the user; and an authentication address setting function (corresponds to a communication parameter allotting function) for setting an IP address (referred to as an “authentication address” hereinafter) to be allotted to the communication address in response to the access proxy request, when receiving the access proxy request that is sent via the access request proxy device 12.

Further, the access authentication device 31 includes: an address correspondence storing function (corresponds to communication parameter managing function) for storing the authentication address and the account information in a related manner; and an access response returning function for transmitting, towards the communication terminal 1, an access response to which the authentication address is given.

Furthermore, the access authentication device 31 includes: a first authentication address informing function for informing the set authentication address to the session control device 32; and a communication authentication judging function for judging whether or not to authenticate the start of a communication by comparing the communication authentication request sent from the corporate network 10 side and the set authentication address described above.

Moreover, the access authentication device 31 includes: a communication authentication response function for returning a communication authentication response when giving an authentication to the communication authentication request; and a second authentication address informing function for informing the account information of the returning destination of the communication authentication response and the authentication address to the session control device 32.

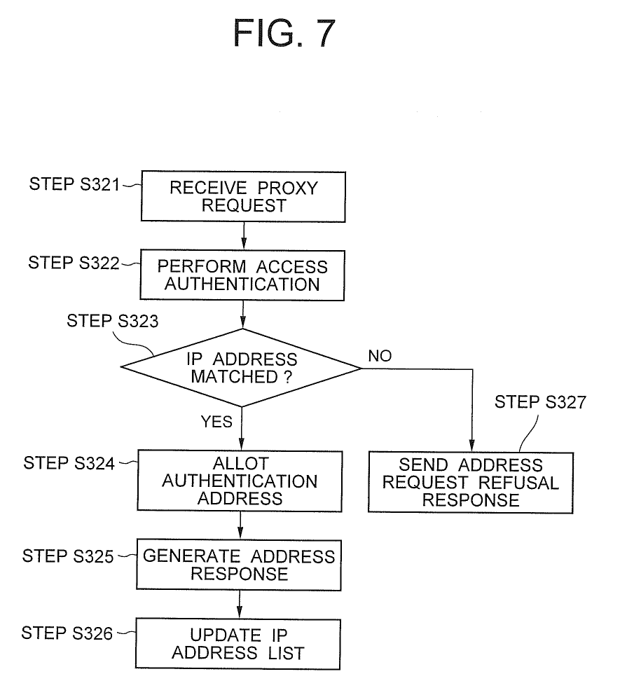

Now, an action of the access authentication device 31 when receiving the access proxy request will be described by referring to a flowchart of FIG. 7.

First, the access authentication device 31 receives an access proxy request transmitted from the access request proxy device 12 (step S321). The access authentication device 31 judges whether or not the account information that is stored in advance in the access authentication device 31 matches with the account information of the received access proxy request (step S322). When the account information matches with each other (step S323), the access authentication device 31 generates an authentication address to be allotted to the communication terminal 1 (step S324). Then, the access authentication device 31 generates an address response and adds the authentication address to the address response (step S325). The access authentication device 31 then updates the IP address correspondence list that is provided in advance (step S326). In the meantime, when the account information does not match with each other, the access authentication device 31 generates an address request refusal response (step S327).

The session control device 32 includes a communication session establishing function part for establishing a communication session by relaying a mutual communication between the communication terminal 1 and the partner terminal 2.

This session establishing function part includes: an authentication address storing function for storing the authentication address that is informed from the access authentication device 31; and a session request judging/relaying function which receives a session start request transmitted from the communication terminal 1 and judges whether or not the IP address of the sender of the session start request matches with the stored authentication address and, when judging that the IP address matches with the stored authentication address, transfers the session start request to the partner terminal 2.

Furthermore, the session establishing function part includes: a session pass request generating/transmitting function which generates a message (referred to as a “communication session pass request” hereinafter) for requesting permission for performing a mutual communication between the communication terminal 1 and the partner terminal 2 based on the session start response sent from the partner terminal 2, and transmits the communication session pass request to the gateway control device 14; and a session start response transmitting function for transmitting a session start response to inform the establishment of the communication session to the communication terminal 1, when receiving the session pass response that is sent in response to the communication session pass request.

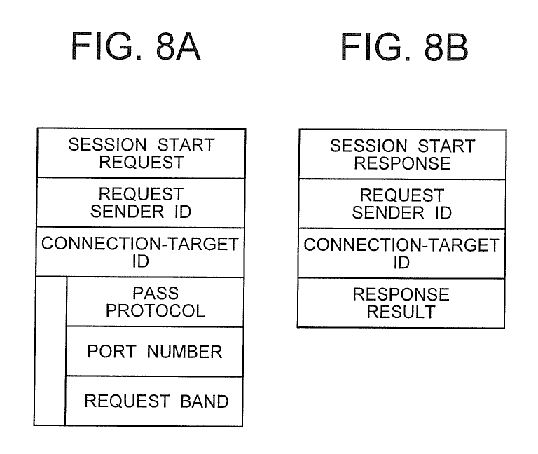

Examples of the data formats of the session start request and the start response described above are shown in FIG. 8A and FIG. 8B, respectively.

Further, the session control device 32 includes: a session stop request relaying function which receives a session stop request sent from the communication terminal 1 and transfers the received session stop request to the partner terminal 2; and a session end request transmitting function which receives a session stop response that is sent from the partner terminal 2 and transmits it as a session end request to the communication terminal 1.

The charging information managing device 33 includes a charging information storing function which receives charging information that is sent from the charging information calculating device 15 of the corporate network 10, and stores the charging information to the charging information list that is provided in advance. The charging information to be stored is stored by each communication session based on the above-described session identifying information contained in the session pass request.

As described above, a communication fee calculating function may be provided to the charging information managing device 33 of the authentication managing unit 21, instead of the charging information calculating device 15.

This makes it possible to update the charging information list of the charging information managing device 33 promptly.

By the way, each of the communication terminal 1, the authentication managing unit 21, and the partner terminal 2 described above includes an encoder and a decoder.

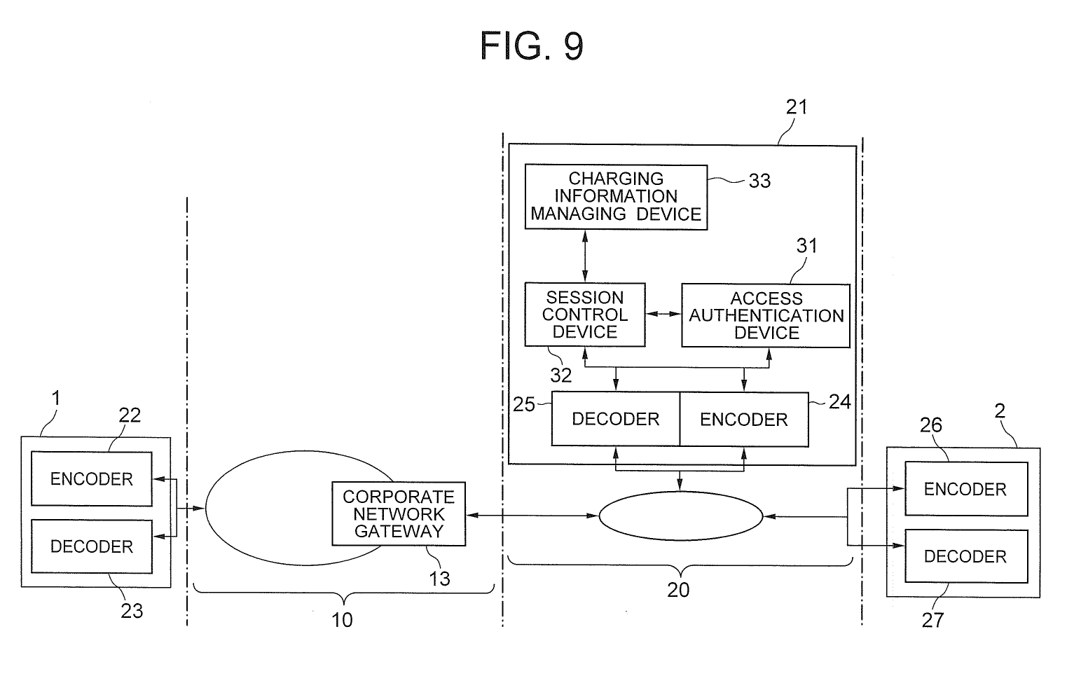

In the communication control charging system shown in FIG. 1, the communication terminal 1 includes an encoder 22 and a decoder 23, the authentication managing unit 21 includes an encoder 24 and a decoder 25, and the partner terminal 2 includes an encoder 26 and a decoder 27 as shown in FIG. 9. An IP packet communicated mutually between the communication terminal 1, the authentication managing unit 21, and the partner terminal 2 therefore has its payload part encoded except for its IP head part.

For a communication from the communication terminal 1 to the authentication device 31, the communication terminal 1 encodes and transmits the IP packet. The transmitted IP packet is sent to the decoder 23 of the authentication managing unit 21 via the corporate network gateway 13, which is then decoded and received by the authentication device 31.

Similarly, for a communication from the access authentication device 31 to the communication terminal 1, the access authentication device 31 encodes the IP packet by the encoder 22 when transmitting it. The transmitted IP packet is sent to the communication terminal 1 via the corporate network gateway 13, which is then decoded by the decoder 23.

Communications performed mutually between the communication terminal 1 and the session control device 32 are also achieved in the same manner.

Further, for mutual communications between the partner terminal 2 and the access authentication device 31, the access authentication device 31 encodes the IP packet by the encoder 24 when transmitting it. The transmitted IP packet is sent to a partner terminal 2 via the provider network 20, which is then decoded by the decoder 27. Similarly, for a communication from the partner terminal 2 to the session control device 32, the partner terminal 2 encodes the IP packet by the encoder 26 when transmitting it. The transmitted IP packet is sent to the decoder 25 via the provider network 20, which is then decoded by the decoder and sent to the session control device 32.

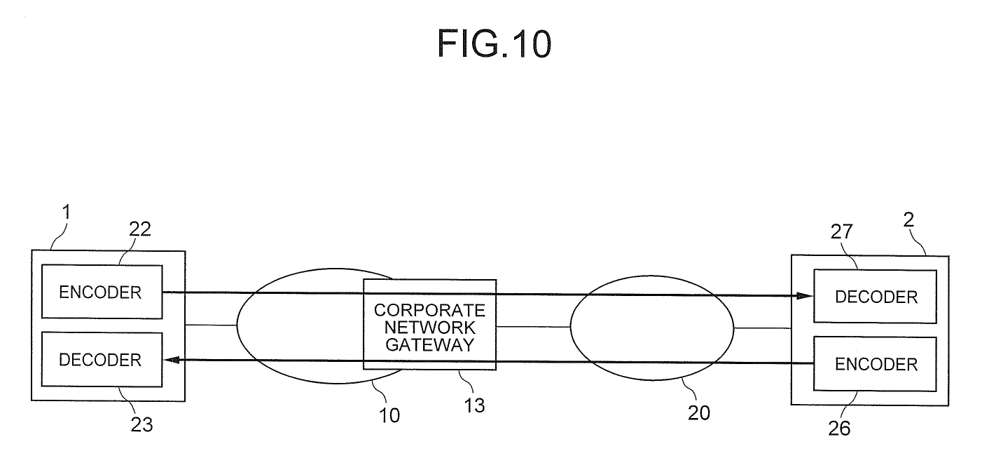

Furthermore, when a communication session is established mutually between the communication terminal 1 and the partner terminal 2, an encoded communication is performed between the both terminals, as shown in FIG. 10.

It is also possible to employ a structure where the encoder 24 and the decoder 25 of the authentication managing unit 21 are provided within the authentication device 31 and the session control device 32, respectively.

With this structure, each of the authentication device 31 and the session control device 32 can perform different encoded communications.

### EXPLANATIONS ON ACTIONS OF EXEMPLARY EMBODIMENTS

Next, overall actions of the communication control charging system in the above-described structure will be described.

In this exemplary embodiment, before making an access to the corporate network 10, the communication terminal 1 requests an access authentication to the authentication managing unit 21 (access authentication request step).

Then, in response to the received access authentication request, the authentication managing unit 21 performs communication access authentication through allotting a communication parameter to the communication terminal 1 for allowing a communication access (communication authentication allotting step). The communication terminal that has obtained the access authentication establishes a communication session between the partner terminal and itself (communication session establishing step).

Then, there is performed a control whether or not to permit a mutual communication between the communication terminal and the partner terminal between which the communication session has been established (communication session pass control step).

At last, the established communication session is stopped, and charging information according to each communication session is calculated (communication charging step).

Regarding the access authentication request step, the communication session establishing step, the communication session pass control step, and the communication charging step, the execution contents thereof may be put into a program so as to allow a computer to execute those steps.

Hereinafter, actions of an authentication managing/charging system according to the above-described exemplary embodiment will be described in more detail.

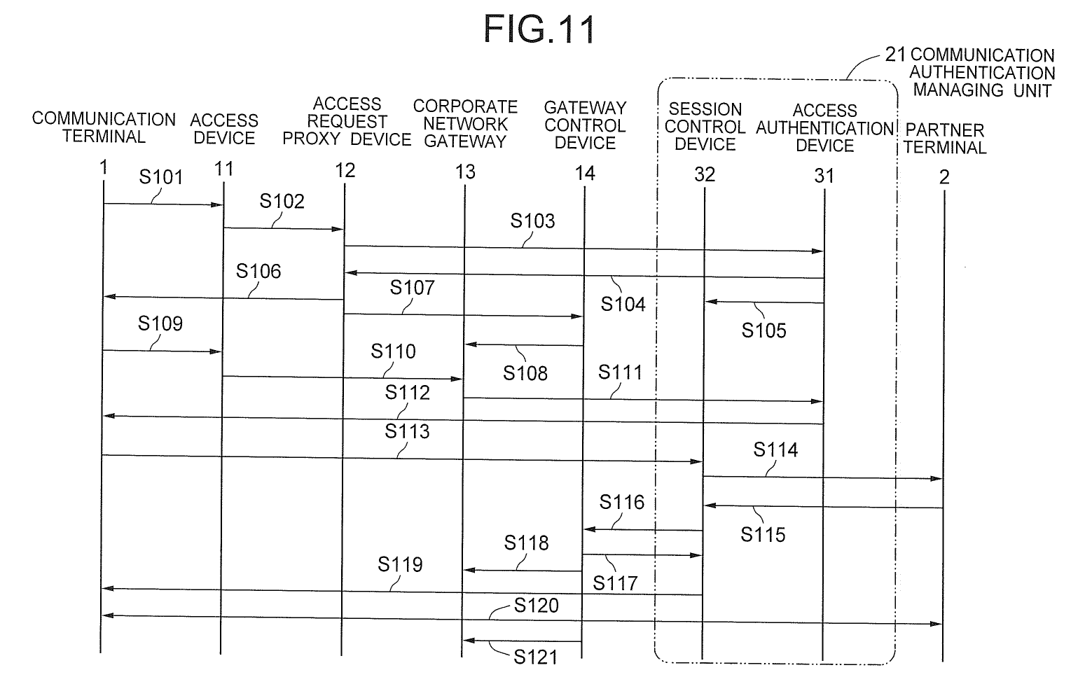

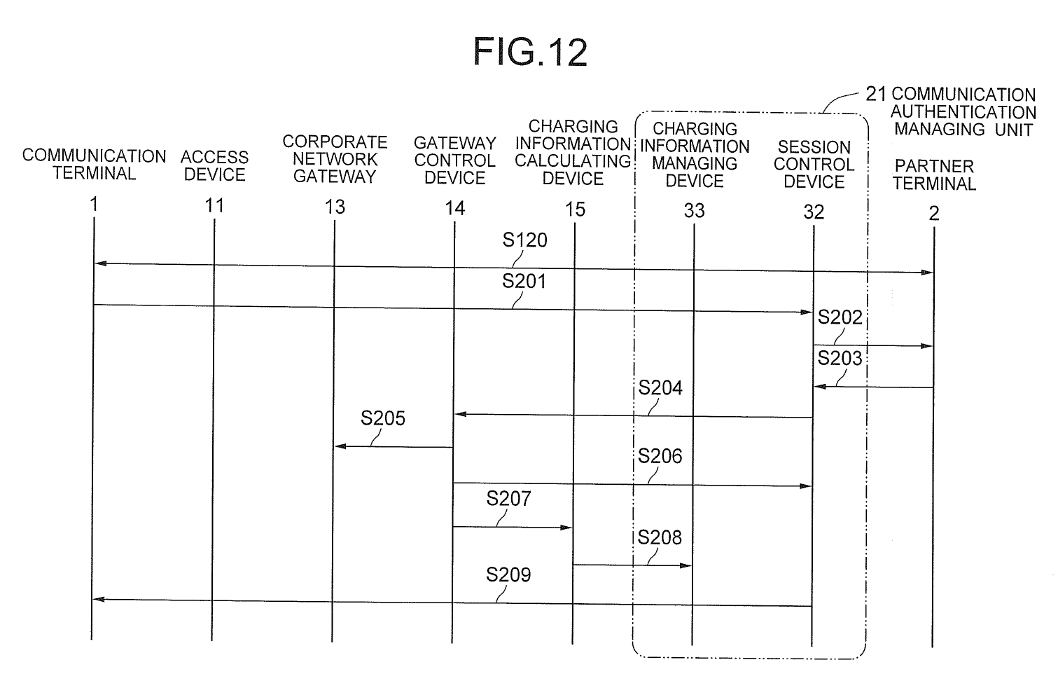

Now, the actions for establishing a mutual communication session between the communication terminal 1 and the partner terminal 2 will be described first by referring to a sequence chart of FIG. 11. Then, the actions for ending the communication session will be described by referring to a sequence chart of FIG. 12.

First, the action for establishing a communication session will be described by referring to the sequence chart of FIG. 11.

The communication terminal 1 transmits an access request to the access device 11 (step S101). The access device 11 transfers the received access request to the access request proxy device 12 (step S102). The access request proxy device 12 transmits the received access request to the access authentication device 31 of the provider network 20 as an access proxy request (step S103: corresponds to the access authentication request step). Upon receiving the access proxy request, the access authentication device 31 sets an authentication address that corresponds to the access proxy request, and returns, to the access request proxy device 12, an access response to which the authentication address is added (step S104). At the same time, the access authentication device 31 informs a request-sender ID and the authentication address of the communication terminal 1 to the session control device 32 (step S105).

The access request proxy device 12 transfers the received access response to the communication terminal 1 via the access device 11 (step S106), and informs the authentication address contained in the access authentication response to the gateway control device 14 (step S107). The gateway control device 14 performs a communication pass control on the corporate network gateway 13 to permit a communication of the IP packet that contains the informed authentication address (step S108).

The communication terminal 1 sends a communication authentication request that has the authentication address as the sender address (step S109).

Upon receiving the communication authentication request, the access device 11 judges consistency between the address of the sender of the communication authentication request and the authentication address in the IP address list and, when judged that the addresses are consistent, transfers the communication authentication request to the corporate network gateway 13 (step S110).

Then, in the corporate network gateway 13 that has received the transferred communication authentication request, the gateway control device 14 judges consistency between the address of the sender of the communication authentication request and the authentication address in the IP address list and, when judged that the addresses are consistent, performs a control on the corporate network gateway 13 to let through the communication authentication request (step S111).

At this time, the gateway control device 14 in the corporate network gateway 13 performs a control (band control) for allowing the IP packet including the authentication address as the sender address to let through from the corporate network 10 to the provider network 20 at a transmission rate based on the minimum communication band (for example, 30 kbps) which is set in advance as an initial setting.

Then, the access authentication device 31 makes a judgment on the communication to the provider network 20 based on the user ID and the password of the communication authentication request that is sent from the communication terminal 1, and returns a communication authentication response (step S112).

Upon obtaining the communication authentication response, the communication terminal 1 transmits a session start request towards the session control device 32 (step S113). The session control device 32 transfers the received session start request to the partner terminal 2 (step S114). Upon receiving the session start request, the partner terminal 2 returns a session start response (step S115). The session control device 32 generates a session pass request based on the received session start response, and transmits it to the gateway control device 14 (step S116).

The gateway control device 14 returns a session pass response for the received session pass request (step S117), and gives an instruction for controlling the communication pass action of the corporate network gateway 13 based on the session pass request (step S118). At this point, the gateway control device 14 informs the session identifying information to the charging information calculating device 15. With this, count for the communication time of the charging target is started.

Upon receiving the session pass response, the session control device 32 transmits a session start response to the communication terminal 1 (step S119). Upon receiving the session start response, the communication terminal 1 starts a communication session with the partner terminal 2 (step S120: the communication session establishing step).

At this time, the gateway control device 14 performs a band control (regulating control) of the communication that is performed via the corporate network gateway 13 based on the session pass request (step S121: the communication session pass control step).

Next, the actions for ending the established communication session will be described by referring to the sequence chart of FIG. 12.

The communication terminal 1 transmits a message (referred to as a “session stop request” hereinafter) for requesting the session control device 32 of the authentication managing unit 21 to stop the session (step S201). The session control device 32 transfers the received session stop request to the partner terminal 2 (step S202). Upon receiving the session stop request, the partner terminal 2 returns a session stop response (step S203). Upon receiving the session stop response, the session control device 32 transmits a session end request to the gateway control device 14 (step S204).

The gateway control device 14 controls the corporate network gateway 13 to perform a communication pass stop control for the communication session that is specified based on the session identifying information (step S205), and returns a session end response to the session control device 32 (step S206). Further, the gateway control device 14 sends the session identifying information to the charging information calculating device 15 (step S207). The charging information calculating device 15 calculates the charging information based on the informed session identifying information and transmits it to the charging managing device 33 of the authentication managing unit 21 (step S208). At this point, the charging information is registered to the charging managing device 33.

At last, the session control device 32 transfers the session end response to the communication terminal 1 (step S209: the communication charging step).

As described above, in this exemplary embodiment, the access authentication device 31 that is provided in advance to the communication authentication managing unit 21 of the provider network 20 that is managed by the communication provider performs communication access authentications and communication session controls (including establishment and shut-off of the sessions). Therefore, communication authentications for users and controls of communication sessions can be performed properly without providing the authentication device and the session control mechanism to the corporate network 10.

The procedure for authenticating the communication access and the procedure for establishing the communication session according to the present invention can be used for CHAP and the like, which use ordinal IEEE802.1x and HTTPS. Further, the procedure for controlling the session can be utilized for ordinal protocol communications of SIP or the like.

Next, another exemplary embodiment of the invention will be described.

As a second exemplary embodiment of the invention, the authentication managing unit may include a communication parameter allotting function for allotting a communication parameter for allowing a communication access to the communication terminal that has been access-authenticated, and a communication selecting rule determining function for determining a communication selecting rule to decide whether or not to permit a mutual communication between the communication terminal that is specified by the communication parameter and the external network, and the inter-network connecting device may include a communication pass control function for controlling whether to permit or to shut off the mutual communication between the communication terminal and the external network based on the communication selecting rule.

In this structure, the communication session establishing function for establishing the mutual communication between the communication terminal and the partner terminal as well as the charging information managing function are provided in advance to the authentication managing unit of the external network, and the local network side only performs a regulating control of communications. This makes it possible to charge the user of the communication terminal properly according to the communication session without having large-scaled network equipment for performing complicated processing provided within the corporate network.

Further, as a third exemplary embodiment of the invention, the inter-network connecting device may include a communication band control device for controlling and setting a communication band for the mutual communication between the communication terminal and the partner terminal performed via the inter-network connecting device.

This makes it possible to suppress data loss, overflow, and the like in the mutual communication that is established between the communication terminal and the partner terminal.

Furthermore, as a fourth exemplary embodiment of the invention, each of the authentication managing unit, the communication terminal, and the partner terminal may include an encoder for encoding an IP packet that is transmitted and received between the communication terminal and the partner terminal as well as a decoder for decoding the encoded IP packet.

By utilizing the encoding system of the communication provider, it becomes possible to lighten wiretappings and leakages of the communication data that may occur when the user of the communication terminal uses the corporate network and to improve the communication security easily, without providing large-scaled and complicated network equipment that requires contents analysis of the communication data as a security measure.

Moreover, as a fifth exemplary embodiment of the invention, the authentication managing unit may include a communication parameter managing function for storing, in a related manner, the communication parameter allotted to the communication terminal and identifying information of the communication terminal set in advance.

Further, as a sixth exemplary embodiment of the invention, the communication control charging method may include, before the communication charging step, a communication session pass control step for performing a control whether or not to permit the mutual communication between the communication terminal and the partner terminal where the communication session has been established.

Through performing the access authentication by the authentication managing unit of the external network prior to execution of the communication session control on the mutual communication between the communication terminal and the partner terminal, the corporate network (inter-network connecting device) can perform the proper communication session pass control. Therefore, it becomes possible to charge the communication terminal user properly according to the communication session.

Furthermore, as a seventh exemplary embodiment of the invention, the communication control charging program may allow a computer to execute: a communication access pass control function for controlling whether to permit or to shut off the communication access from the communication terminal that is specified by the communication parameter to the external network; a communication session pass control function for controlling permission of the mutual communication between the communication terminal and the partner terminal based on the session identifying information that specifies the communication session established between the communication terminal and the partner terminal; and a communication band control function for controlling a communication band used for the mutual communication between the communication terminal and the partner terminal.

This makes it possible to promptly specify the communication session that is established between the communication terminal and the partner terminal, based on the session identifying information. Therefore, it becomes possible to perform the regulating control of the communications properly and to charge the communication fee properly by each session.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention can be applied to portable telephones that utilize communication access connecting services and to radio communication access managing systems as well as to improve the security thereof.

What is claimed is:

1. A communication control charging system, comprising:
a local network to which at least one communication terminal is connected; an inter-network connecting device which is a part of the local network and is connected to an external network; and a partner terminal connected to the external network, wherein
the external network is provided with an authentication managing unit for performing access authentication of the communication terminal when the communication terminal makes a communication access to the local network, the authentication managing unit comprising: a communication session control function for controlling establishment of a mutual communication session between the communication terminal and the partner terminal; and a communication charging managing function for managing a communication fee according to the communication session.

2. The communication control charging system as claimed in claim 1, wherein:
the authentication managing unit comprises a communication parameter allotting function for allotting a communication parameter for allowing a communication access to the communication terminal that has been access-authenticated, and a communication selecting rule determining function for determining a communication selecting rule to decide whether or not to permit a mutual communication between the communication terminal that is specified by the communication parameter and the external network; and
the inter-network connecting device comprises a communication pass control function for controlling whether to permit or to shut off the mutual communication between the communication terminal and the external network based on the communication selecting rule.

3. The communication control charging system as claimed in claim 1, wherein the local network comprises a charging calculation device which calculates the communication fee in accordance with the communication session established between the communication terminal and the partner terminal, and informs the calculated communication fee to the authentication managing unit.

4. The communication control charging system as claimed in claim 1, wherein the local network comprises an access request proxy device which functions based on a communication access request sent from the communication terminal to the local network, and sends an access request to the authentication managing unit on behalf of the communication terminal.

5. The communication control charging system as claimed in claim 2, wherein the inter-network connecting device comprises a communication band control device for controlling and setting a communication band for the mutual communication between the communication terminal and the partner terminal performed via the inter-network connecting device.

6. The communication control charging system as claimed in claim 2, wherein each of the authentication managing unit, the communication terminal, and the partner terminal comprises an encoder for encoding an IP packet that is transmitted and received between the communication terminal and the partner terminal as well as a decoder for decoding the encoded IP packet.

7. The communication control charging system as claimed in claim 2, wherein the authentication managing unit comprises a communication parameter managing function for storing, in a related manner, the communication parameter allotted to the communication terminal and identifying information of the communication terminal set in advance.

8. A communication control charging system, comprising:
a local network to which at least one communication terminal is connected; an inter-network connecting device which is a part of the local network and is connected to an external network; and a partner terminal connected to the external network, wherein
the external network is provided with an authentication managing means for performing access authentication of the communication terminal when the communication terminal makes a communication access to the local network, the authentication managing means comprising: a communication session control function for controlling establishment of a mutual communication session between the communication terminal and the partner terminal; and a communication charging managing function for managing a communication fee according to the communication session.

9. A communication control charging method which, when a communication terminal and a partner terminal perform a mutual communication via a local network and an external network, uses an authentication managing unit provided in advance to the external network to control establishment of the mutual communication session between the communication terminal and the partner terminal, and to charge a communication fee for the communication session, the method comprising:
requesting an access authentication from the communication terminal to the authentication managing unit, prior to making an access communication to the local network;
performing communication access authentication by the authentication managing unit through allotting, to the communication terminal, a communication parameter for allowing a communication access in response to the received access authentication request;
establishing the communication session between the communication terminal that has obtained the access authentication and the partner terminal; and
stopping the established communication session and calculating charging information.

10. The communication control charging method as claimed in claim 9, comprising, before stopping the established communication session and calculating charging information, performing a control whether to permit or to shut off the mutual communication between the communication terminal and the partner terminal where the communication session has been established.

11. A communication control charging program which, when a communication terminal and a partner terminal perform a mutual communication via a local network and an external network, controls establishment of a mutual communication session between the communication terminal and the partner terminal, and charges a communication fee for the communication session, the program allowing a computer to execute:
a communication parameter allotting function for allotting a communication parameter for allowing a communication access in response to a communication access request that is sent from the communication terminal to the local network;
a communication session control function for establishing the communication session between the communication terminal that has obtained the access authentication and the partner terminal that is specified in advance as a communicating destination, and for controlling the communication session; and
a charging information storing function for generating session identifying information to specify the established communication session, as well as for calculating and storing communication fee information based on the session identifying information.

12. The communication control charging program as claimed in claim 11, which allows the computer to execute:
a communication pass control function for controlling whether to permit or to shut off the mutual communication between the communication terminal that is specified by the communication parameter and the external network; and
a communication session pass control function for controlling permission of the mutual communication between the communication terminal and the partner terminal based on the session identifying information that specifies the communication session established between the communication terminal and the partner terminal.

13. The communication control charging program as claimed in claim 11, which allows the computer to execute a communication band control function for controlling a communication band used for the mutual communication between the communication terminal and the partner terminal.
